(19) United States
(12) Patent Application Publication
(10) Pub. No.: US 2025/0116834 A1
(43) Pub. Date: Apr. 10, 2025

(54) OPTICAL FIBER EASY TO AIR INSTALLATION

(71) Applicant: HYESUNG Cable & Communication INC., Iksan-si (KR)

(72) Inventors: YOUNG BIN SONG, Seoul (KR); June Hyong Kim, Suwon-si (KR)

(21) Appl. No.: 18/781,646

(22) Filed: Jul. 23, 2024

(30) Foreign Application Priority Data
Oct. 4, 2023 (KR) 10-2023-0132011

(51) Int. Cl. G02B 6/44; C03C 25/106; G02B 6/04

(52) U.S. Cl. CPC G02B 6/4432; C03C 25/106; G02B 6/04

(57) ABSTRACT

The present disclosure relates to an optical cable easy to air installation, and more specifically, to enable fluid traction force to be applied more effectively during the air installation, and in particular, by minimizing a contact area with a hollow pipe while inducing centering within the hollow pipe to minimize friction resistance with the hollow pipe during the air installation, thereby ensuring a straight mobility of the optical cable. In addition, by uniformly spacing a coating from the hollow pipe, friction damage to the coating may be prevented in advance, ensuring ease of installation and construction quality.

### CROSS-REFERENCE TO RELATED APPLICATIONS

This application claims the priority of the Korean Patent Applications NO 10-2023-0132011, filed on Oct. 4, 2023, in the Korean Intellectual Property Office. The entire disclosures of all these applications are hereby incorporated by reference.

### TECHNICAL FIELD

The present disclosure relates to an optical cable easy to air installation, and more specifically, to enable fluid traction force to be applied more effectively during the air installation, and in particular, by minimizing a contact area with a hollow pipe while inducing centering within the hollow pipe to minimize friction resistance with the hollow pipe during the air installation, thereby ensuring a straight mobility of the optical cable. In addition, by uniformly spacing a coating from the hollow pipe, friction damage to the coating may be prevented in advance, ensuring ease of installation and construction quality, and furthermore, the increase in diameter is minimized even when various internal materials for strength reinforcement are embedded, and as a result, the present disclosure relates to the optical cable easy to the air installation, which not only ensures durability but also has advantageous effects such as reduced manufacturing costs due to its miniaturized structure.

### BACKGROUND TECHNOLOGY

Among installation methods of cables, the air installation is a method of installing the cables through a predetermined amount of air pressure. It simultaneously provides the cables to be installed and air pressure towards the inside of an already installed hollow pipe so that the cables use the air pressure as well as the traction force of a separate installation device. It refers to a construction method that allows it to be installed within the hollow pipe.

Installing the cables using this installation method have the advantage of easy cable installing and removal, reduced initial installation costs, and easy future performance improvement, and thus, it is mainly used in actual sites.

In general, the cables using an air installation method move within the hollow pipe with the help of fluid flow traction, so they need to have a special surface structure to receive more fluid traction force.

For example, after coating the cables with resin, glass beads are attached using static electricity before the coated resin hardens to form a protrusion, or, alternatively, a foamable polymer material is used to form an arbitrary concave surface on the cable surface, or a thread of special material may be wound around the outer surface of the cables.

However, the cables of such a structure have a rather non-uniform outer surface structure, which may be biased in one direction inside the hollow pipe, or the cables may contact the hollow pipe with an excessive surface area, causing frictional forces during the cable movement.

As a result, when installing the cables, strong frictional resistance occurs between the hollow pipe and the cable, which not only reduces the efficiency of the installation work but also causes scratches on the relatively soft cable coating or, in the worst case, permanently damages the coating, resulting in serious defects that expose an optical fiber, wire, etc. wired in the coating.

### PATENT DOCUMENT

(Patent Document 0001) Korean Laid-open Patent Publication No. 10-2013-0016909

### CONTENT OF INVENTION

### Task to be Solved

The present disclosure was created to solve the above-mentioned problems in the prior art, so that the fluid traction force can be applied more effectively during the air installation, and in particular, it minimizes the contact area with the hollow pipe while inducing centering within the hollow pipe. This ensures the straight mobility of the optical cable by minimizing the frictional resistance with the hollow pipe during the installation process. In addition, by uniformly spacing the coating from the hollow pipe, the friction damage to the coating may be prevented in advance, ensuring ease of installation and construction quality, and furthermore, the increase in diameter is minimized even when various interior materials for the strength reinforcement are embedded, and as a result, the present disclosure relates to the optical cable easy to the air installation, which not only ensures durability but also has advantageous effects such as reduced manufacturing costs due to its miniaturized structure.

### Solution Means of the Problem

The present disclosure is a means for achieving the above object, comprising: a core portion with a plurality of optical fiber bundles; a coating portion surrounding the core portion, having a plurality of reinforcing protrusions on an inner surface in a direction towards the core portion and having a reinforcing groove between adjacent reinforcing protrusions; a plurality of first tension members embedded in each reinforcing groove; and an uneven portion formed on the outer surface of the coating portion onto which compressed air is projected during the air installation.

In addition, the uneven portion includes resistance protrusions that protrude radially from the outer surface of the coating portion, and each of the plurality of resistance protrusions is characterized in that it extends in a straight line along a longitudinal direction.

In addition, the uneven portion is characterized by the resistance protrusion formed to protrude in a spiral shape along the longitudinal direction on the outer surface of the coating portion.

In addition, the resistance protrusion is characterized by an inner flank surface disposed to face the direction of injection of the compressed air and an outer flank surface opposite to the inner flank surface form a slope surface inclined at a certain angle, but the outer angel between the outer surface and the inner flank surface of the coating is formed at an acute angle to form an undercut between the outer surface and the inner flank surface of the coating portion.

In addition, a first tension member comprises a plurality of pieces, embedded in each reinforcing groove, and distributed within the coating portion while spaced apart from each other, so that the first tension member and the reinforcing protrusion are alternately arranged on the outer surface of the core portion, and the protrusion height of each of the plurality of reinforcing protrusions and the interval between adjacent reinforcing protrusions are set differently.

### Effects of the Invention

The present disclosures provides an advantageous effect to enable fluid traction force to be applied more effectively during the air installation, and in particular, by minimizing a contact area with the hollow pipe while inducing centering within the hollow pipe to minimize the friction resistance with the hollow pipe during the air installation, thereby ensuring the straight mobility of the optical cable. In addition, by uniformly spacing a coating on the hollow pipe, the friction damage to the coating may be prevented in advance, ensuring ease of installation and construction quality.

In addition, the increase in diameter is minimized even when various internal materials for the strength reinforcement are embedded, and as a result, durability is guaranteed and advantageous effects such as reduced manufacturing costs can be expected due to its miniaturized structure.

### BRIEF DESCRIPTION OF THE DRAWINGS

FIG. 1 and FIG. 2A, FIG. 2B are diagrams showing a cross-sectional configuration of an optical cable according to an embodiment of the present disclosure.

FIG. 3 is a diagram showing a cross-sectional configuration according to a first modified example of uneven portion.

FIG. 4 is a diagram showing a cross-sectional configuration according to a second modification of the uneven portion.

FIG. 5A, FIG. 5B and FIG. 6A, FIG. 6B are enlarged views of a vertical cross-sectional configuration of FIG. 4, and are diagrams for explaining modified embodiments of resistance protrusions.

FIG. 7 is a diagram showing a state in which the resistance protrusions have been removed.

FIG. 8 is a diagram showing a modified example of a second tension member.

FIG. 9 is a diagram showing the process of removing the second tension member.

FIG. 10 is a diagram for explaining the modified example of the second tension member, and is a diagram schematically showing a longitudinal cross-sectional configuration of the optical cable.

FIG. 11 is a view showing a state in which a withdrawl piece is exposed to the outside.

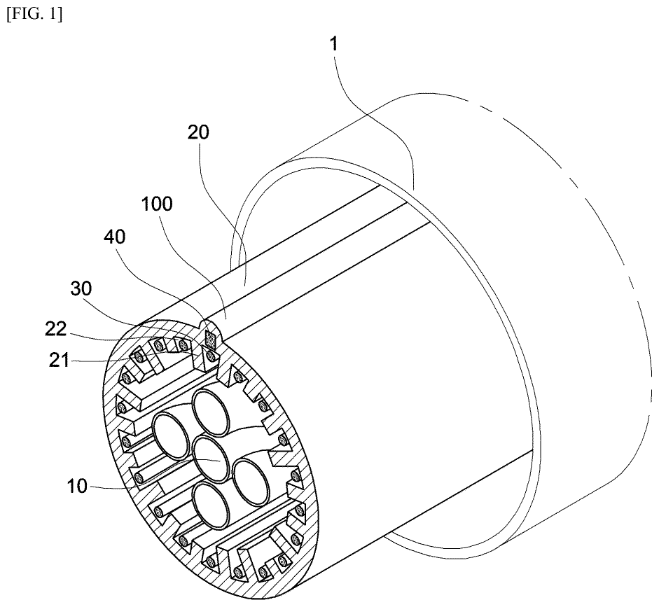

### DETAILED DESCRIPTION OF THE EMBODIMENTS

The purpose, features and advantages of the present disclosure described above will become clearer through the following examples in conjunction with the accompanying drawings. The following specific structural and functional descriptions are exemplified solely for the purpose of explaining embodiments in accordance with the concepts of the present disclosure. The embodiments in accordance with the concepts of the present disclosure may be implemented in various forms and should not be limited to the embodiments described herein.

Since embodiments in accordance with the concept of the present disclosure are subject to various modifications and may have various forms, specific embodiments will be illustrated in the drawings and described in detail in the specification. However, this is not intended to limit the embodiments in accordance with the concept of the present disclosure to a specific disclosed form, and should be understood to include all modifications, equivalents, and substitutes within the ideas and technical scope of the present disclosure.

Terms such as first and/or second may be used to describe various components, but the components are not limited to the terms. The above terms are used only for the purpose of distinguishing one component from other components, for example, without departing from the scope of rights in accordance with the concepts of the present disclosure, a first component may be named a second component, and similarly a second component may also be called the first component.

When a component is referred to as being: connected” or “plugged in” to another component, it should be understood that it may be directly connected or plugged in to that other component, but there may be other components in between. On the other hand, when a component is referred to as being “directly connected” or “directly connected” to another component, it should be understood that there are no other components in between. Other expressions used to describe relationships between components, such as “between” and “directly between” or “adjacent to” and “directly adjacent to” should be interpreted similarly.

The terms used in this specification are merely used to describe specific embodiments and are not intended to limit the present disclosure. Singular expressions include plural expressions unless the context clearly dictates otherwise. The terms “including” or “having” and the like in this specification are intended to designate the presence of implemented features, numbers, steps, operations, components, parts, or combinations thereof, and it should be understood that it does not exclude in advance the presence or addition of other features, numbers, steps, operations, components, parts, or combinations thereof.

Unless otherwise defined, all terms used herein, including technical or scientific terms, have the same meaning as commonly understood by a person of ordinary skill in the technical field to which the present disclosure pertains. Terms, as defined in commonly used dictionaries, shall be construed to have a meaning consistent with their meaning in the context of the relevant art, and shall not be defined as not expressly defined in an idealized or overly formal sense.

The optical cable easy to the air installation (hereinafter referred to the optical cable) according to the present disclosure may be broadly defined as including the core portion 10, the coating portion 20, the first tension member 30, the second tension member 40, and the uneven portion 100.

The core portion 10 includes a plurality of optical fiber bundles. Although not shown, the optical fiber bundles can be coated with a tube, and the inside of the tube is filled with a filler so that the filler can be packed between the optical fibers. The filler may use waterproof material to fill an empty space in the tube to prevent moisture from entering.

The coating portion 20 constitutes the outermost portion of the optical cable and serves to protect the optical fiber from external factors by surrounding the core portion 10.

The coating portion 20 may be manufactured as an insulator made of a polymer-based polymer compound such as polyvinyl chloride, polyester elastomer (Hyt-rel), polyester, polyethylene, and nylon to which a foaming agent has been added. The core portion 10 may be embedded in the cavity formed in the center of the coating portion 20.

A plurality of reinforcing protrusions 21 may be formed to protrude on the inner surface of the coating portion 20 in a direction toward the core portion 10. At this time, the reinforcing groove 22 may be formed between adjacent reinforcing protrusions 21.

Each of the reinforcing protrusions 21 and the reinforcing grooves 22 uniformly space the core portion 10 from the inner surface of the coating portion 20 so that the core portion 10 is not biased in a specific direction within the coating portion 20. In addition, it can perform the function of protecting the core portion 10 from shock and pressure applied from the outside by acting as a buffer between the core portion 10 and the coating portion 20.

In addition, each reinforcing groove 22 serves to support and receive the first tension member 30 or the second tension member 40, which will be described later, without providing a separate space for the first tension member 30 and the second tension member 40 within the coating portion 20, the first tension member 30 and the second tension member 40 can be accommodated without difficulty, thereby making more effective use of the narrow and limited space, and further preventing the diameter of the optical cable from being unnecessarily increased.

The reinforcing protrusion 21 may be formed integrally with the coating portion 20 from the same material as the coating portion 20 during the manufacturing process of the coating portion 20.

The core portion 10 is supported spaced apart towards the center of the coating portion 20 by each of these reinforcing protrusions 21, and in particular, it is supported by the reinforcing groove 22 formed between each of the reinforcing protrusions 21. Since its own elastic deformation can be allowed to some extent, when pressure is applied from an unspecified direction, each reinforcing protrusion 21 is elastically deformed into the space of the adjacent reinforcing groove 22, resulting in a structure that can more effectively cushion and disperse external shocks.

In addition, since the inner surface of the coating portion 20 forms a wrinkled structure due to the reinforcing protrusion 21 and the reinforcing groove 22, a structure that can perform a shielding function against surface waves generated by currents flowing along the inner side is provided by the structure of the inner surface of the coating portion 20 formed by the height difference caused by the uneven protruding structure.

The shielding characteristics of each reinforcing protrusion 21 are expressed in multiple parasitic frequency bands of a specific frequency band forming shielding through harmonic components generated by each reinforcing protrusion 21. Therefore, this structure is capable of exhibiting shielding characteristics in a wide band.

Each of the plurality of reinforcing protrusions 21 may have different protrusion heights, and the shape of each reinforcing protrusion 21 and the interval between adjacent reinforcing protrusions 21 may be set differently.

In this way, the inner surface has a somewhat complex wrinkle structure to minimize the influence of external interference.

The first tension member 30 is a component to increase the tensile strength of the optical cable, and has a structure embedded in at least one or more reinforcing grooves 22. Accordingly, each first tension member 30 can be uniformly distributed within the coating portion while being spaced apart from each other.

The first tension member 30 in this embodiment may be embedded in a corresponding location of each of the plurality of reinforcing grooves 22, and at this time, each reinforcing protrusion 21 and reinforcing groove 22 is structured to extend longitudinally along the longitudinal direction of the optical cable, and the first tension member 30 also has a fiber structure that extends longitudinally within the reinforcing groove 22 to correspond to the length of the reinforcing protrusion 21 and the reinforcing groove 22.

The cross-sectional shape of the first tension member 30 may be a circular or elliptical structure, and the material may be appropriately selected from any of the materials known in the art, which exhibit good properties for tensile strength, such as steel wire, glass fiber, and reinforced plastic, and the like.

In this way, even if the first tension member 30 is embedded inside the coating portion 20, the first tension member 30 is not structured to completely surround and protect the outer surface of the core portion 10, but is arranged at regular intervals. In particular, since the reinforcing protrusion 21 around the first tension member 30 itself can undergo a predetermined elastic deformation, it is possible to provide a predetermined ductility in the line of suppressing tensile deformation of the optical cable, thereby reducing the hardness of the optical cable and ensuring ease of installation. In addition, since the first tension member 30 and the reinforcing protrusions 21 are provided alternately, even if the coating portion 20 is cut with a cutter for stripping the coating portion 20, the coating portion 20 can be more easily cut without interference from the first tension member 30 in a specific portion.

Next, the second tension member 40 is preferably made of a metal that is easy to detect metal, such as copper, to facilitate detection of the buried location, stripping, and the like, in addition to the role of the first tension member 30 in the aforementioned embodiment

In some cases, at least one of the plurality of first tension members 30 may be configured as the second tension member 40 to perform the role of the second tension member 40.

On the other hand, once the optical cable is buried, it is not easy to find a buried location, and even if the buried location is found, it is not easy to work due to concerns about damage to the optical fiber by causing damage on interference from various components embedded in the coating portion 20 and inexperience in manipulation of a stripping tool, when separating (stripping) the coating portion 20 for tasks such as mid-branching and terminal connection of optical cables.

Therefore, the present embodiment not only facilitates tracking of the buried location, but also makes it easier to perform a coating separation operation without damaging the optical fiber.

More specifically, the second tension member 40 is a structure installed in the coating portion 20 eccentric from the first tension member 30, and is not located in the cavity the reinforcing protrusions 21 constituting the coating portion 20, the reinforcing grooves 22, and the cavity, and is installed in the coating portion 20 itself, so that an incision in the coating portion can be easily induced just by taking out the second tension member 40.

That is, the first tension member 30 may be disposed in each reinforcing groove 22, and the second tension member 40 may be embedded in the coating portion 20 itself.

Like the first tension member 30, the second tension member 40 may also be formed to extend long along the longitudinal direction within the coating portion 20.

Next, the uneven portion 100 is formed on the outer surface of the coating portion 20 to allow the compressed air to be projected during the air installation, so that the fluid traction force can be more effectively applied to the optical cable within the hollow pipe 1.

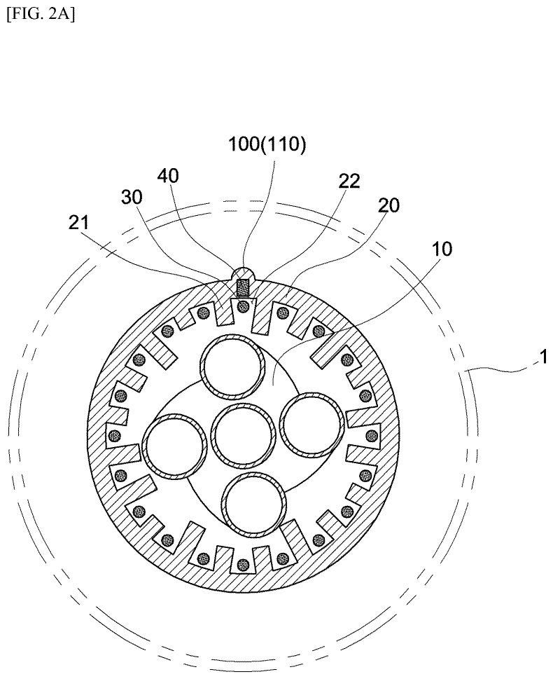

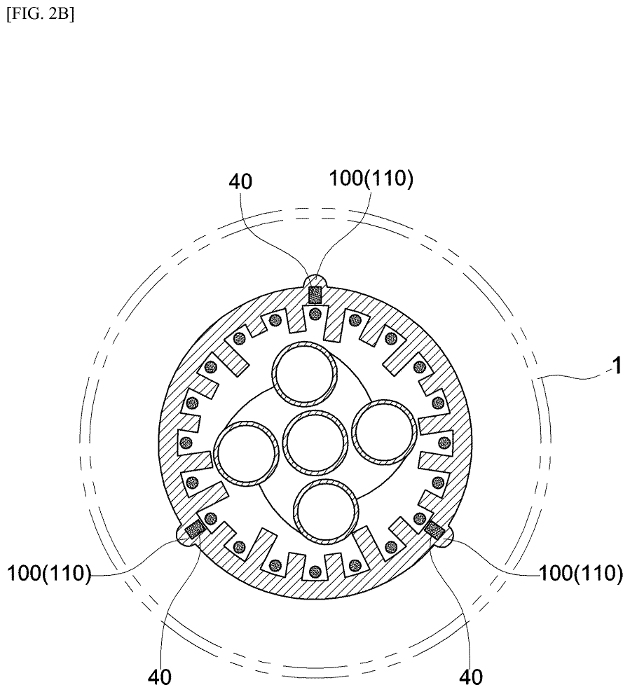

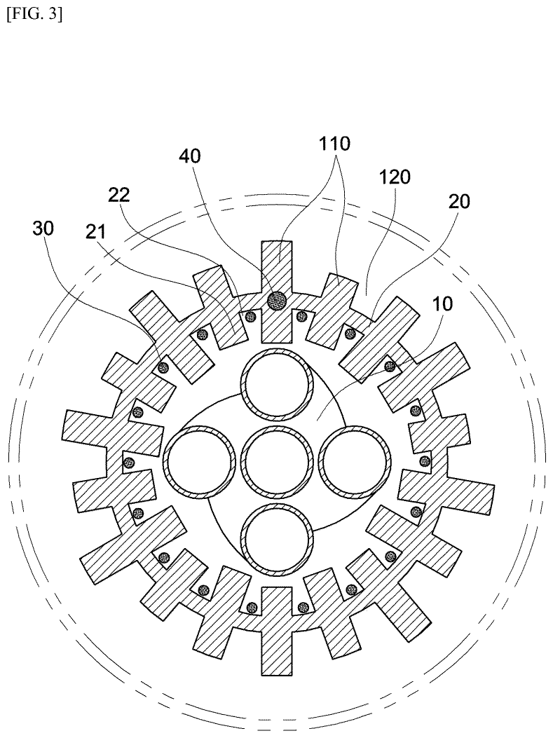

For example, the uneven portion 100 may be illustrated as including the resistance protrusion 110 that protrudes radially from the outer surface of the coating portion 20, as shown in FIGS. 2 and 3.

The resistance protrusion 110 is a protruding structure that protrudes from the coating portion 20 toward an inner circumferential surface of the hollow pipe 1 at a certain height, and the coating portion 20 may be installed in a state spaced apart at a certain interval from the inner circumferential surface of the hollow pipe 1 by the resistance protrusion 110.

The resistance protrusion 110 may be constructed as a single unit as shown in FIG. 2A, or as shown in FIG. 2B or FIG. 3, the number and position of forming the resistance protrusions 110 are not particularly limited, such as being deformed so that a plurality of resistance protrusions are spaced apart from each other at equal intervals.

Preferably, the resistance protrusion 110 is formed in a plurality at equal intervals along the circumferential direction to enable internal alignment of the coating portion 20 of the optical cable with respect to the inner circumferential surface of the hollow pipe 1 at regular intervals.

In this case, it is more preferable that each of the plurality of resistance protrusions 110 has a structure that extends long in the straight line along the longitudinal direction.

FIG. 2 shows a semicircular resistance protrusion 110, and FIG. 3 shows a rectangular resistance protrusion 110, and it is revealed that the resistance protrusion 110 may be modified into various shapes.

As described above, when a plurality of resistance protrusions 110 are formed at equal intervals along the circumferential direction on the outer surface of the coating portion 20, a straight flow groove 120 for guiding the compressed air is formed between adjacent resistance protrusions 110.

When the compressed air is injected into the hollow pipe 1, some of the compressed air is projected onto the resistance protrusion 110 to exert traction to the optical cable, and in this process, the resistance protrusion 110 may perform a damping effect on the vibrating optical cable to protect the coating portion 20 from impact and pressure, while some of the compressed air has a structure in which it is guided in the straight line within the flow groove 120.

When the compressed air is guided around the coating portion 20 along the longitudinal direction of the coating portion 20, the twisting and stagnation of the optical cable due to vortex generation in the hollow pipe 1 can be effectively suppressed, and the optical cable may follow the compressed air to further improve the straight-line mobility of the optical cable within the hollow pipe 1.

The resistance protrusion 110 may be formed integrally with the coating portion 20 from the same material as the coating portion 20 during the manufacturing process.

The protrusion height of each resistance protrusion 110 may be formed differently, and the shape of each resistance protrusion 110 and the distance between the adjacent resistance protrusions 110 may be set differently.

The coating portion 20 is supported spaced apart towards the center of the hollow pipe 1 by each of these resistance protrusions 110, and in particular, by the flow grooves 120 formed between each resistance protrusion 110, since its own elastic deformation can be allowed to some extent, when pressure is applied from an unspecified direction, each resistance protrusion 110 undergoes elastic deformation into the space of the adjacent flow groove 120, creating a structure that can more effectively buffer or disperse vibration and impact caused by the compressed air.

In summary, the uneven portion 100 allows the fluid traction force due to the projection of the compressed air to be applied inside the hollow pipe 1, and in particular, while minimizing the contact area with the hollow pipe 1, by inducing the centering of the optical cable to minimize the frictional resistance with the hollow pipe 1 during the installation process to ensure the straight-line mobility of the optical cable, and furthermore, by uniformly spacing the coating portion 20 from the hollow pipe 1, friction damage of the coating portion 20 is prevented in advance, providing an advantageous effect of ensuring ease of laying and construction quality.

In addition, the outer surface of the coating portion 20 may have a somewhat complex wrinkled structure due to the uneven portion 100, which may have a shielding effect on surface waves. Since these effects are the same as those described for the reinforcing protrusions described above, detailed descriptions are omitted.

Meanwhile, the resistance protrusion 110 may not only provide the fluid traction force, but also serves as a means to determine the location of the second tension member 40 installed in the coating portion 20 even if the coating portion 20 is not cut separately.

To this end, the resistance protrusion 110 may be formed to protrude from the outer surface of the coating portion 20 along the longitudinal direction at a position on the same line where the second tension member 40 is embedded.

In other words, the second tension member 40 embedded in the coating portion 20 may be positioned around at least one of the plurality of resistance protrusions 23 so that the location of the second tension member 40 can be indirectly identified by referring to the portion of the resistance protrusion 23 protruding outside the coating portion 20.

In this case, the second tension member 40 may be disposed as biased as possible in the direction of the resistance protrusion 23, or in some cases, it may have a structure extending toward the inside of the resistance protrusion 23.

Preferably, the end of the second tension member 40 facing the resistance protrusion 23 is positioned at the boundary point between the outer surface of the coating portion 20 and the resistance protrusion 23, such that the resistance protrusion 23 can be cut away with a cutter to facilitate exposure of the second tension member 40 to the outside.

Therefore, for stripping, the worker partially cuts only the resistance protrusion 23 with a sharp cutter to expose the second tension member 40 to the outside, then grips both sides of the exposed second tension member using pliers and pulls it to the outside, so that the coating portion 20 is naturally cut by the second tension member 40 that is being pulled to the outside, making it easier to open the inside of the coating portion 20.

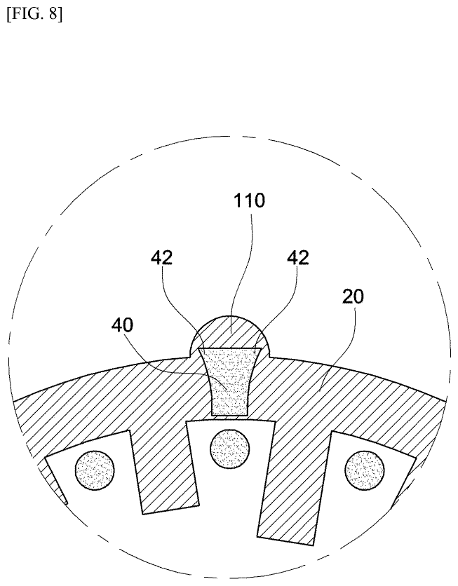

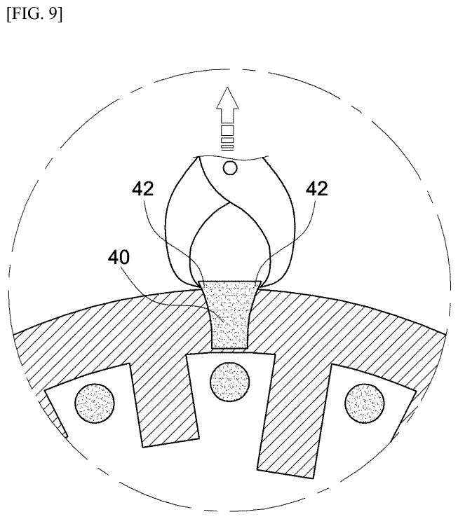

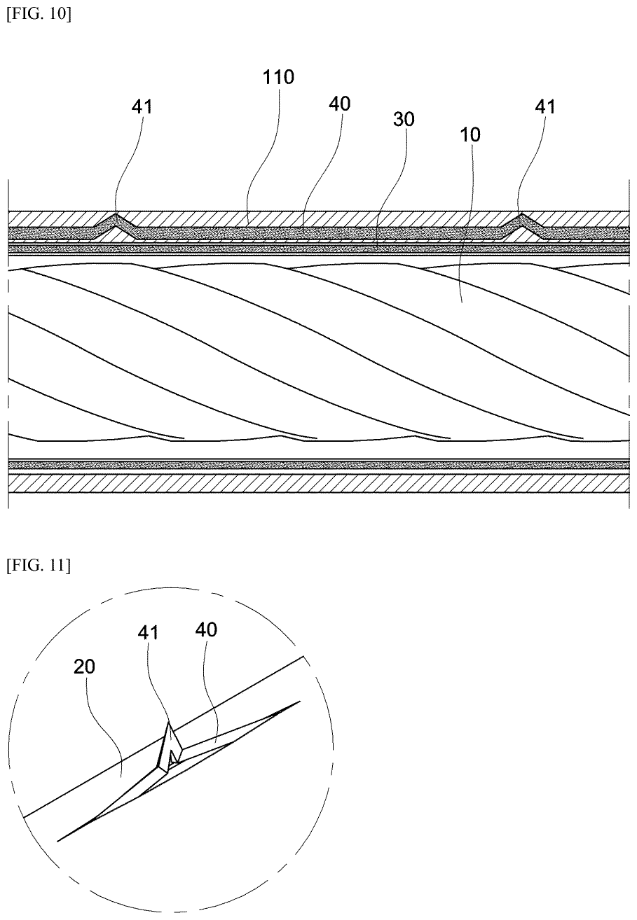

Meanwhile, as shown in FIG. 8, gripping pins 42 may be formed to protrude on both left and right sides of the end of the second tension member 40 facing the resistance protrusion 23, so that the cross section of the second tension member 40 has a head shape of a nail with a wide spread at the end, and when the second tension member 40 exposed to the outside by the removal of the resistance protrusion 23 is held with a tool such as pliers, the second tension member 40 may be held more easily and strongly.

Furthermore, a plurality of withdrawal pieces 41 may be bent in a direction toward the outer surface of the coating portion 20 or the resistance protrusion 23 at regular intervals along the longitudinal direction in the second tension member 40.

Each withdrawal piece 41 is a part for gripping the second tension member 40 using a tool such as pliers during a stripping operation, and can be easily exposed to the outside just by making a predetermined cut in the resistance protrusion 23.

In this case, each of the plurality of withdrawal pieces 41 is bent in a “\hat{ }” shape in which the vertex is located in the direction toward the resistance protrusion 23 to form a sufficient gripping area, and has a structure that makes it easier to expose to the outside with only a predetermined cut of the resistance protrusion 23. In some cases, each withdrawal piece 41 has a structure that passes through the resistance protrusion 23 and is exposed to the outside, and each withdrawal piece 41 is arranged at equal intervals, for example, at 1 m intervals, so that the worker can approximately estimate the length of the optical cable by referring only to the interval between the withdrawal piece 41 exposed to the outside.

The cross-sectional shape of the second tension member 40 may have various structures such as circular, triangular, or square.

Therefore, for the stripping, the worker partially cuts only the resistance protrusion 23 with a sharp cutter to expose the withdrawal piece 41 to the outside, then grips both sides of the exposed withdrawal piece 41 using pliers and pulls it to the outside, and the resistance protrusion 23 around the withdrawal piece 41 is gradually cut by the second tension member 40that is pulled to the outside, so that the inside of the covering portion 20 may be opened.

If necessary, a marker that guides the position of the withdrawal piece 41 may be engraved on the surface of the resistance protrusion 23.

The resistance protrusion 23 may be formed to protrude in the form of a hemisphere or square having a curved surface, and each withdrawal piece 41 is provided to extend to a point where a part is inserted into the resistance protrusion 23, so that the withdrawal piece 41 may be more easily exposed to the inside the cut resistance protrusion 23 when the resistance protrusion 23 is cut.

When stripping the optical cable with this structure, it is not necessary to insert the cutter deeply into the center of the optical cable, so damage to the optical fiber can be fundamentally prevented, and since the cutout is limited to the part of the resistance protrusion 23 protruding from the coating portion 20 to a predetermined height, excessive damage to the coating portion 20 can be prevented, and naturally avoiding the first tension member 30 and inducing an incision, making it easier to proceed without special professional skills or a dedicated stripper.

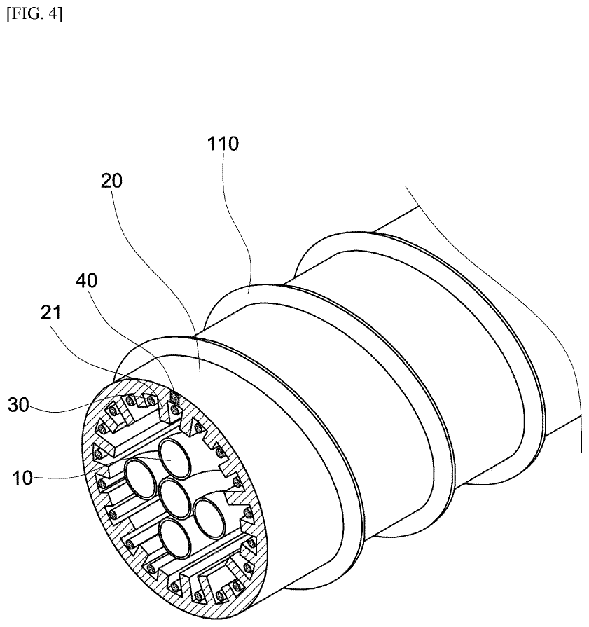

As another example of the resistance protrusion 110, as shown in FIG. 4, the resistance protrusion 110 may have a structure that protrudes in a spiral shape along the longitudinal direction from the outer surface of the coating portion 20.

In other words, in the above-described embodiment, if the plurality of resistance protrusions 110 are formed to extend in the straight line along the longitudinal direction of the coating portion 20, the resistance protrusion 110 in the present embodiment may form a continuous or discontinuous spiral protruding structure along the longitudinal direction of the coating portion 20 on the outer surface of the coating portion 20.

In this case, the cross-sectional shape of the resistance protrusion 110 may have an approximately triangular shape, and assuming that an inclined plane forming the outer surface of the resistance protrusion 110 is the inner flank surface 113 and the outer flank surface 114, the resistance protrusion 110 may have the inner flank surface 113 disposed to face the injection direction of compressed air and the outer flank surface 114 on the opposite side of the inner flank surface 113 to form a slope inclined at a certain angle. The outer angle Θ between the outer surface of the coating portion 20 and the inner flank surface 113 is formed at an acute angle to form an undercut 115 between the outer surface of the coating portion 20 and the inner flank surface 113.

In other words, when the compressed air is injected, the injected compressed air is projected on the inner flank surface 113 to apply the fluid traction force, while the compressed air projected on the inner flank surface 113 is helically guided by the recessed undercut 115 between the inner flank surface 113 and the coating portion 20, and it is possible to continuously provide the fluid traction force to the optical cable by spirally following and rotating the resistance protrusion 110 for a relatively long time without a pressure drop.

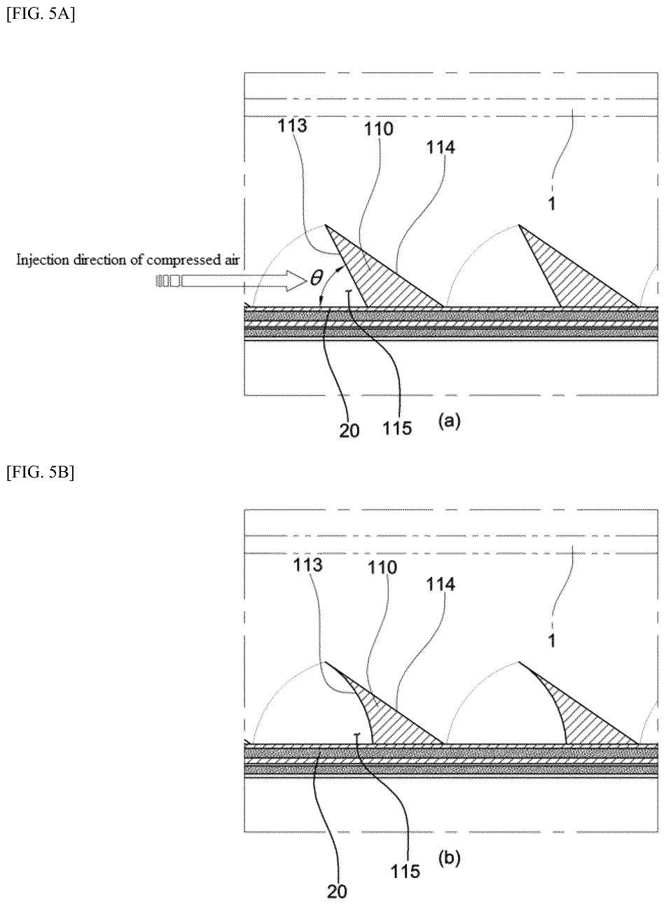

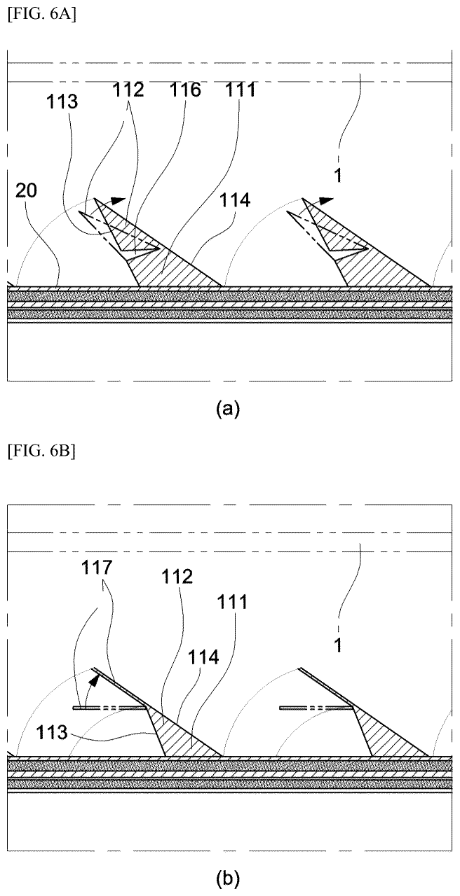

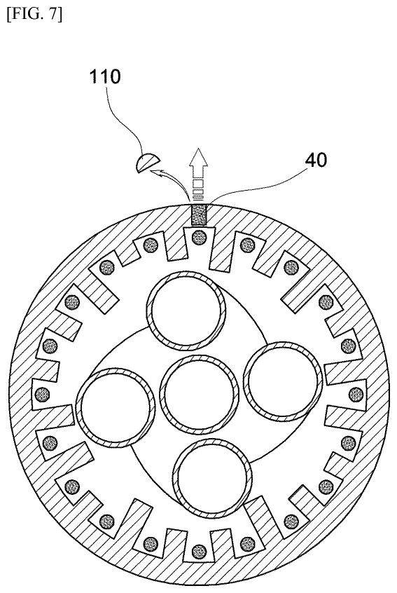

In this case, the inner flank surface 113 may be made of a flat plate surface as shown in FIG. 5A, or may be made of a concave depression as shown in FIG. 5B.

In addition, in some cases, as shown in FIG. 6A, the inner flank surface 113 has a predetermined depth between a fixed end 111 in contact with the covering portion 20 and a free end 112 facing the inner peripheral surface of the hollow pipe 1, so that the free end 112 is folded toward the fixed end 111, and when the compressed air is provided for installation, the folded free end 112 unfolded by the pressure of the compressed air is deployed to further expand the projected area of the compressed air.

In another embodiment, as shown in FIG. 6b, an auxiliary projection film 117 of a thin film structure is formed to extend at the end of the free end 112 of the resistance protrusion 110, and the auxiliary projection film 117 is formed at the free end 112 of the resistance protrusion 110, and the auxiliary projection film 117 is elastic and flexible at the end of the free end 112, and when the compressed air is provided for installation, the auxiliary projection film (117) may be deployed by the pressure of the compressed air to further expand the projected area of the compressed air.

The embodiments of the present disclosure described above are merely illustrative, and those skilled in the art will understand that various modifications and other equivalent embodiments are possible. Therefore, it will be understood that the present disclosure is not limited to the forms mentioned in the detailed description above. Therefore, the true scope of technical protection of the present disclosure should be determined by the technical idea of the appended claims. In addition, the present disclosure should be understood to include all modifications, equivalents and substitutes within the idea and scope of the present disclosure as defined by the appended claims.
10: a core portion
20: a coating portion
30: a first tension member
40: a second tension member
100: an uneven portion

1. An optical fiber easy to air installation comprising:
a core portion including a plurality of optical fiber bundles;
a coating portion surrounding the core portion and having a plurality of reinforcing protrusions on its inner surface in a direction toward the core portion, and having a reinforcing groove between adjacent reinforcing protrusions;
a plurality of first tension members embedded in each reinforcing groove; and
an uneven portion formed on an outer surface of the coating portion onto which compressed air is projected during air installation.

2. The optical fiber according to claim 1, wherein the uneven portion comprises a resistance protrusion protruding radially from the outer surface of the coating portion, wherein each of the plurality of resistance protrusions is formed to extend in a straight line along the longitudinal direction.

3. The optical fiber according to claim 1, wherein the uneven portion comprises the resistance protrusion formed to protrude in a spiral shape along the longitudinal direction on the outer surface of the coating portion.

4. The optical fiber according to claim 3, wherein the resistance protrusion has an inner flank surface disposed to face the direction of injection of compressed air and an outer flank surface on the opposite side of the inner flank surface, forming a slope inclined at a certain angle, and an outer angel between the outer surface of the coating portion and the inner flank surface is formed at an acute angle to form an undercut between the outer surface of the coating portion and the inner flank surface.

5. The optical fiber according to claim 1, wherein the first tension member is made up of a plurality of pieces, embedded in each reinforcing groove, and distributed within the coating portion while being spaced apart from each other, so that the first tension member and the reinforcing protrusion are alternately arranged on the outer surface of the core portion, and a protrusion height of each of the plurality of reinforcing protrusions and an interval between adjacent reinforcing protrusions are set differently.
